(19) United States
(12) Patent Application Publication
(10) Pub. No.: US 2024/0038114 A1
(43) Pub. Date: Feb. 1, 2024

(54) DATA DRIVING CHIP AND DISPLAY DEVICE

(71) Applicant: TCL China Star Optoelectronics Technology Co., Ltd., Shenzhen (CN)

(72) Inventors: Jinfeng LIU, Shenzhen (CN); Qingsheng LAN, Shenzhen (CN)

(21) Appl. No.: 17/618,516

(22) PCT Filed: Nov. 4, 2021
(86) PCT No.: PCT/CN2021/128665

§ 371 Date: May 4, 2023

(30) Foreign Application Priority Data
Oct. 27, 2021 (CN) 20111256031.X

(51) Int. Cl. G09G 3/20

(52) U.S. Cl. CPC G09G 3/20; G09G 2310/0275; G09G 2310/0286; G09G 2310/0291; G09G 2310/0289; G09G 2310/0297; G09G 2330/021

(57) ABSTRACT

A data driving chip and a display device are disclosed. The data driving chip and the display device includes a signal identifying circuit between the digital signal processing circuit and the analog signal processing circuit. In this way, the signal identifying circuit could identify the signal in the display data signal. When the signal identifying circuit identifies the invalid display command signal, the signal identifying circuit controls the invalid display signal not to be outputted to the analog signal processing circuit such that the power consumption could be reduced.

### FIELD OF THE DISCLOSURE

The present disclosure relates to a display technology, and more particularly, to a data driving chip and a display device.

### BACKGROUND

As the popularity of the electronic devices and the limited power resources, the demands for low power consumption of consumer products become higher. For example, the “Energy Star” is a governmental policy of U.S. Department of Energy and the Environmental Protection Agency, which is mainly used in the computers, office equipments, household electronic devices, for better protecting the environment and save the energy. The display devices need to meet the power consumption requirements of Energy Star so that these display devices could be available in the market. In addition, the power consumption requirements increase as time goes by. Therefore, there is a need to improve the power saving technology.

A conventional data driving chip needs to process the received display data information to obtain the data voltage to drive the display panel to display an image. The conventional data driving chip often comprises a digital signal processing circuit and an analog processing circuit. The display data information is orderly processed by the digital signal processing circuit and the analog processing circuit. However, the analog signal processing circuit processes an analog signal and the digital signal processing circuit processes a digital signal. In the conventional structure of the display device, the valid display signal and the invalid display signal of the display panel are processed by the analog signal processing circuit but the analog signal processing circuit needs to consume more power and thus unnecessary power consumption is introduced.

### SUMMARY

One objective of an embodiment of the present disclosure is to provide a data driving chip and a display device capable of reduce the power consumption.

According to an embodiment of the present disclosure, a data driving chip is disclosed. The data driving chip comprises a digital signal processing circuit, an analog signal processing circuit, and a signal identifying circuit electrically connected to the digital signal processing circuit and the analog signal processing circuit. The digital signal processing circuit is configured to process a display data information to output a display data signal. The display data signal comprises an invalid display command signal and an invalid display signal and the invalid display command signal is corresponding to the invalid display signal. The analog signal processing circuit is configured to receive the display data signal and convert the display data signal from a digital signal into an analog signal to output an actual data voltage. The signal identifying circuit is configured to control the invalid signal not to be outputted to the analog signal processing circuit when the signal identifying circuit identifies the invalid display command signal.

Optionally, the display data signal further comprises a valid display signal. The signal identifying circuit is further configured to control the invalid signal to be outputted to the analog signal processing circuit when the signal identifying circuit does not identify the invalid display command signal.

Optionally, the signal identifying circuit comprises an identifying unit and a switch unit. An input end of the identifying unit receives the display data signal, an output end of the identifying unit is electrically connected to a control end of the switch unit. The identifying unit is configured to identify the display data signal. An input end of the switch unit receives the display data signal, an output end of the switch unit is electrically connected to the analog signal processing circuit. When the identifying unit identifies the invalid display command signal, the identifying unit turns off the switch unit such that the invalid display signal is not outputted to the analog signal processing circuit. When the identifying unit does not identify the invalid display command signal, the identifying unit turns on the switch unit such that the invalid display signal is outputted to the analog signal processing circuit.

Optionally, the switch unit is a thin film transistor (TFT), the control end of the switch unit is a gate of the TFT, the input end of the switch unit is a source of the TFT and the output end of the switch unit is a drain of the TFT.

Optionally, the switch unit is an N-type TFT or a P-type TFT.

Optionally, the display data signal comprises a valid display command signal and a valid display signal and the valid display command signal is corresponding to the valid display signal. When the signal identifying circuit identifies the valid display command signal, the signal identifying circuit controls the valid display signal to be outputted to the analog signal processing circuit.

Optionally, the digital processing circuit comprises a converting unit, a first latch unit, a second latch unit and a level shifter unit. The converting unit is electrically connected to the first latch unit. The first latch unit is electrically connected to the second latch unit, and the second latch is electrically connected to the level shifter unit. The converting unit is configured to receive the display data information, convert the display data information from serial data into parallel data, and transfer a display data signal of a (n+1)^{th} row to the first latch unit, and n is an integer greater than 0. The first latch unit is configured to store the display data signal of the (n+1)^{th} row data and transfer a display data signal of an n^{th} row data to the second latch unit. The second latch unit is configured to store the display data signal of the n^{th} row data and transfer the display data signal of the n^{th} row data to the level shifter unit. The level shifter unit is configured to raise a voltage level of the display data signal of the n^{th} row data and output the display data signal of the n^{th} row data having a raised voltage level to the signal identifying circuit.

Optionally, the digital signal processing circuit further includes a bidirectional shift register, electrically connected to the converting unit and configured to control a scan direction of the data driving chip.

Optionally, the analog signal processing unit comprises a digital-to-analog converter (DAC) and an output buffer electrically connected to the DAC. The DAC is configured to receive the display data signal and convert the display data signal from a digital signal to an analog signal. The output buffer is configured to output a data voltage according to the analog signal.

According to an embodiment of the present disclosure, a display device is disclosed. The display device comprises a display panel and a data driving chip electrically connected to the display panel. The data driving chip comprises a digital signal processing circuit, an analog signal processing circuit, and a signal identifying circuit electrically connected to the digital signal processing circuit and the analog signal processing circuit. The digital signal processing circuit is configured to process a display data information to output a display data signal. The display data signal comprises an invalid display command signal and an invalid display signal and the invalid display command signal is corresponding to the invalid display signal. The analog signal processing circuit is configured to receive the display data signal and convert the display data signal from a digital signal into an analog signal to output an actual data voltage. The signal identifying circuit is configured to control the invalid signal not to be outputted to the analog signal processing circuit when the signal identifying circuit identifies the invalid display command signal.

Optionally, the display data signal further comprises a valid display signal. The signal identifying circuit is further configured to control the invalid signal to be outputted to the analog signal processing circuit when the signal identifying circuit does not identify the invalid display command signal.

Optionally, the signal identifying circuit comprises an identifying unit and a switch unit. An input end of the identifying unit receives the display data signal, an output end of the identifying unit is electrically connected to a control end of the switch unit. The identifying unit is configured to identify the display data signal. An input end of the switch unit receives the display data signal, an output end of the switch unit is electrically connected to the analog signal processing circuit. When the identifying unit identifies the invalid display command signal, the identifying unit turns off the switch unit such that the invalid display signal is not outputted to the analog signal processing circuit. When the identifying unit does not identify the invalid display command signal, the identifying unit turns on the switch unit such that the invalid display signal is outputted to the analog signal processing circuit.

Optionally, the switch unit is a thin film transistor (TFT), the control end of the switch unit is a gate of the TFT, the input end of the switch unit is a source of the TFT and the output end of the switch unit is a drain of the TFT.

Optionally, the switch unit is an N-type TFT or a P-type TFT.

Optionally, the display data signal comprises a valid display command signal and a valid display signal and the valid display command signal is corresponding to the valid display signal. When the signal identifying circuit identifies the valid display command signal, the signal identifying circuit controls the valid display signal to be outputted to the analog signal processing circuit.

Optionally, the digital processing circuit comprises a converting unit, a first latch unit, a second latch unit and a level shifter unit. The converting unit is electrically connected to the first latch unit. The first latch unit is electrically connected to the second latch unit, and the second latch is electrically connected to the level shifter unit. The converting unit is configured to receive the display data information, convert the display data information from serial data into parallel data, and transfer a display data signal of a (n+1)^{th} row to the first latch unit, and n is an integer greater than 0. The first latch unit is configured to store the display data signal of the (n+1)^{th} row data and transfer a display data signal of an n^{th} row data to the second latch unit. The second latch unit is configured to store the display data signal of the n^{th} row data and transfer the display data signal of the n^{th} row data to the level shifter unit. The level shifter unit is configured to raise a voltage level of the display data signal of the n^{th} row data and output the display data signal of the n^{th} row data having a raised voltage level to the signal identifying circuit.

Optionally, the digital signal processing circuit further includes a bidirectional shift register, electrically connected to the converting unit and configured to control a scan direction of the data driving chip.

Optionally, the analog signal processing unit comprises a digital-to-analog converter (DAC) and an output buffer electrically connected to the DAC. The DAC is configured to receive the display data signal and convert the display data signal from a digital signal to an analog signal. The output buffer is configured to output a data voltage according to the analog signal.

According to an embodiment of the present disclosure, a data driving chip and a display device are disclosed. The data driving chip and the display device includes a signal identifying circuit between the digital signal processing circuit and the analog signal processing circuit. In this way, the signal identifying circuit could identify the signal in the display data signal. When the signal identifying circuit identifies the invalid display command signal, the signal identifying circuit controls the invalid display signal not to be outputted to the analog signal processing circuit such that the power consumption could be reduced.

### BRIEF DESCRIPTION OF THE DRAWINGS

To describe the technical solutions in the embodiments of this application more clearly, the following briefly introduces the accompanying drawings required for describing the embodiments. Apparently, the accompanying drawings in the following description show merely some embodiments of this application, and a person of ordinary skill in the art may still derive other drawings from these accompanying drawings without creative efforts.

FIG. 1 is a diagram of a data driving chip according to an embodiment of the present disclosure.

FIG. 2 is a diagram of a signal identifying circuit of a data driving chip according to an embodiment of the present disclosure.

FIG. 3 is a diagram of a data driving chip according to another embodiment of the present disclosure.

FIG. 4a is a diagram showing a signal structure of a data driving chip according to an embodiment of the present disclosure.

FIG. 4b is a diagram showing a serial form of the signal structure shown in FIG. 4a.

FIG. 5 is a diagram of a display device according to an embodiment of the present disclosure.

### DETAILED DESCRIPTION

To help a person skilled in the art better understand the solutions of the present disclosure, the following clearly and completely describes the technical solutions in the embodiments of the present invention with reference to the accompanying drawings in the embodiments of the present invention. Apparently, the described embodiments are a part rather than all of the embodiments of the present invention. All other embodiments obtained by a person of ordinary skill in the art based on the embodiments of the present invention without creative efforts shall fall within the protection scope of the present disclosure.

According to an embodiment of the present disclosure, a data driving chip and a display device are disclosed. The data driving chip and the display device categorize the display data signal into a valid display signal and an invalid display signal. By determining whether the display data signal is the invalid display signal, the invalid display signal is controlled not to be outputted to the analog signal processing circuit such that the power consumption could be reduced. This mechanism will be illustrated in more detail in the following disclosure. It should be noted that the order of illustrating the following embodiments does not imply the preference of these embodiments.

Please refer to FIG. 1. FIG. 1 is a diagram of a data driving chip according to an embodiment of the present disclosure. The data driving chip 10 comprises a digital signal processing circuit 101, a signal identifying circuit 102 and an analog signal processing circuit 103. The digital signal processing circuit 101 and the analog signal processing circuit 103 are both connected to the signal identifying circuit 102. It should be noted that the digital signal processing circuit 101 processes a digital signal and the analog signal processing circuit 103 processes an analog signal. In addition, FIG. 1 only depicts digital signal processing circuit 101, the signal identifying circuit 102 and the analog signal processing circuit 103 without other modules in this embodiment.

The digital signal processing circuit 101 is configured to receive a display data information, process the display data information to obtain a display data signal, and output the display data signal to the signal identifying circuit 102. Specifically, the display data signal comprises an invalid display command signal and an invalid display signal and the invalid display command signal is corresponding to the invalid display signal.

The signal identifying circuit 102 is configured to identify the display data signal. That is, the signal identifying circuit 102 is configured to control the invalid display signal not to be outputted to the analog signal processing circuit 103 when the signal identifying circuit identifies the invalid display command signal.

The analog signal processing circuit 103 is configured to receive the display data signal and convert the display data signal from a digital signal into an analog signal to output an actual data voltage.

The display data signal further comprises a valid display signal. When the signal identifying circuit 102 does not identify the invalid display command signal, the signal identifying circuit 102 controls the valid display signal to be outputted to the analog signal processing circuit 103.

The display data signal further comprises a valid display command signal and the valid display command signal is corresponding to the valid display signal. When the signal identifying circuit 102 identifies the valid display command signal, the signal identifying circuit 102 controls the valid display signal to be outputted to the analog signal processing circuit 103.

That is, in this embodiment, a signal identifying circuit 102 is included between the digital signal processing circuit 101 and the analog signal processing circuit 103. In this way, the signal in the display data signal could be identified. When the signal identifying circuit identifies the invalid display command signal, the signal identifying circuit 102 controls the invalid display signal not to be outputted to the analog signal processing circuit 103 such that the power consumption could be reduced.

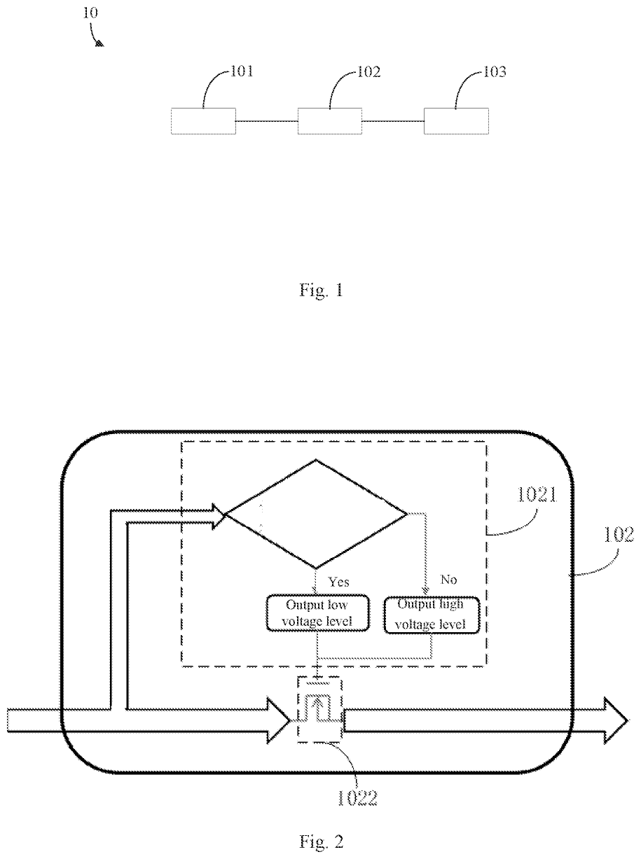

Please refer to FIG. 2. FIG. 2 is a diagram of a signal identifying circuit of a data driving chip according to an embodiment of the present disclosure. The signal identifying circuit 102 comprises an identifying unit 1021 and a switch unit 1022. The input end of the identifying unit 102 receives the display data signal. The output end of the identifying unit 102 is electrically connected to the control end of the switch unit 1022. The identifying unit 1021 is configured to identify the display data signal. The input end of the switch unit 1022 receives the display data signal. The output end of the switch unit 1022 is electrically connected to the analog signal processing circuit 103. When the identifying unit 1021 identifies the invalid display command signal, the identifying unit 1021 turns off the switch unit 1022 such that the invalid display signal is not outputted to the analog signal processing circuit 103. When the identifying unit 1021 does not identify the invalid display command signal, the identifying unit turns on the switch unit 1022 such that the invalid display signal is outputted to the analog signal processing circuit 103.

The switch unit is a thin-film transistor (TFT). The control end of the switch unit 1022 is the gate of the TFT, the input end of the switch unit 1022 is the source of the TFT and the output end of the switch unit 1022 is the drain of the TFT. In an embodiment, the switch unit 1022 is an N-type TFT. In another embodiment, the switch unit 1022 is a P-type TFT.

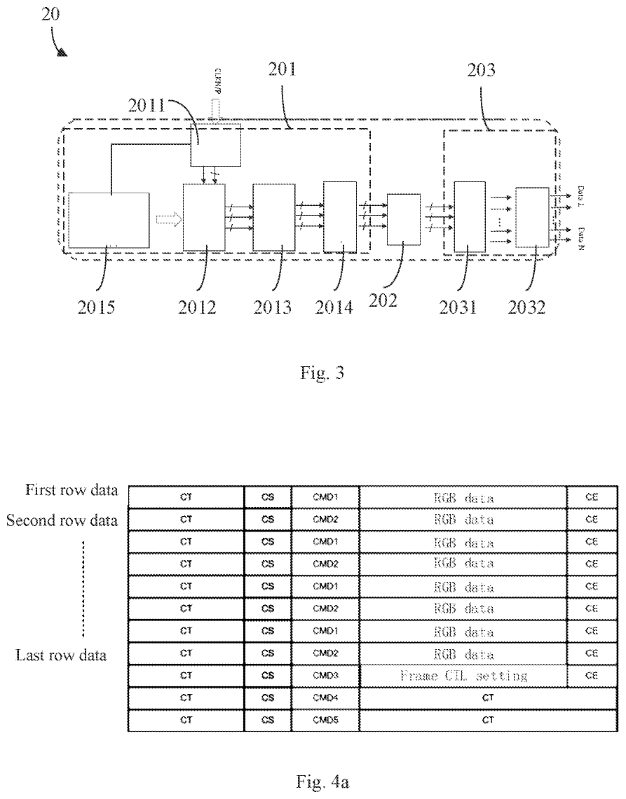

Please refer to FIG. 3. FIG. 3 is a diagram of a data driving chip according to another embodiment of the present disclosure. In this embodiment, the data driving chip 20 comprises a digital signal processing circuit 201, a signal identifying circuit 202 and an analog signal processing circuit 203. The digital signal processing circuit 201 and the analog signal processing circuit 203 are both electrically connected to the signal identifying circuit 202.

The digital signal processing circuit 201 is configured to receive digital information, process the digital information to obtain a display data signal, and output the display data signal to the signal identifying circuit 202. Specifically, the display data signal comprises an invalid display command signal and an invalid display data signal and the invalid display command signal is corresponding to the invalid display data signal. The signal identifying circuit 202 is configured to identify the display data signal. When the signal identifying circuit 202 identifies the invalid display command signal, the signal identifying circuit 202 controls the invalid display signal not to be outputted to the analog signal processing circuit 203. The analog signal processing circuit 203 is configured to receive the display data signal and convert the display data signal from a digital signal into an analog signal to output an actual data voltage.

The display data signal further comprises a valid display signal. When the signal identifying circuit 202 does not identify the invalid display command signal, the signal identifying circuit 202 controls the valid display signal to be outputted to the analog signal processing circuit 203.

That is, in this embodiment, a signal identifying circuit 202 is included between the digital signal processing circuit 201 and the analog signal processing circuit 203. In this way, the signal in the display data signal could be identified. When the signal identifying circuit 202 identifies the invalid display command signal, the signal identifying circuit 202 controls the invalid display signal not to be outputted to the analog signal processing circuit 203 such that the power consumption could be reduced.

The digital signal processing circuit 201 comprises a converting unit 2011, a first latch unit 2012, a second latch unit 2013, a level shifter unit 2014 and a bidirectional shift register 2015. The converting unit 2011 is electrically connected to the first latch unit 2012, the first latch unit 2012 is electrically connected to the second latch unit 2013, and the second latch 2013 is electrically connected to the level shifter unit 2014. The bidirectional shift register 2015 is electrically connected to the converting unit 2011.

The converting unit 2011 is configured to receive the display data information, convert the display data information from serial data into parallel data, and transfer a display data signal of a (n+1)^{th} row to the first latch unit 2012. Here, n is an integer greater than 0.

The first latch unit 2012 is configured to store the display data signal of the (n+1)^{th} row data and transfer a display data signal of an n^{th} row data to the second latch unit 2013. The second latch unit 2013 is configured to store the display data signal of the n^{th} row data and transfer the display data signal of the n^{th} row data to the level shifter unit 2014. The level shifter unit 2014 is configured to raise a voltage level of the display data signal of the n^{th} row data and output the display data signal of the n^{th} row data having a raised voltage level to the signal identifying circuit 202. The bidirectional shift register 2015 is configured to control a scan direction of the data driving chip 20.

The analog signal processing circuit 203 comprises a digital-to-analog converter 2031 and an output buffer 2032. The DAC converting unit 2031 is electrically connected to the output buffer 2032. The DAC converting unit 2031 is configured to receive the display data signal and convert the display data signal from a digital signal to an analog signal. The output buffer 2032 is configured to output an actual data voltage according to the analog signal.

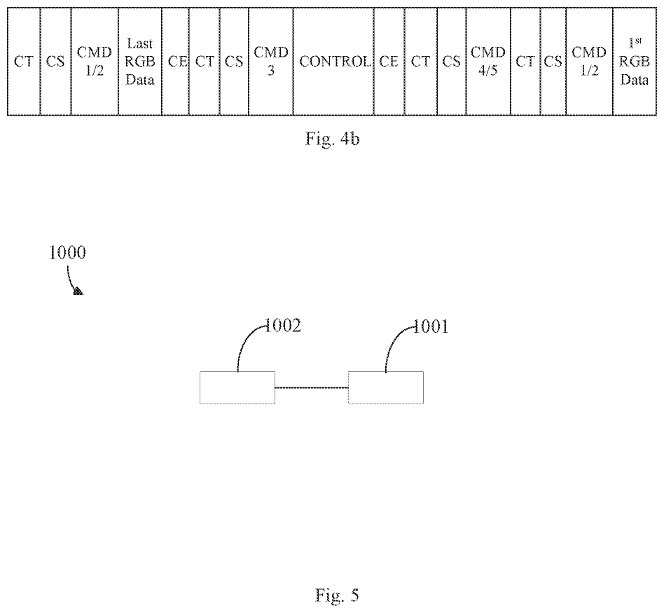

Please refer to FIG. 4a and FIG. 4b. FIG. 4a is a diagram showing a signal structure of a data driving chip according to an embodiment of the present disclosure. FIG. 4b is a diagram showing a serial form of the signal structure shown in FIG. 4a.

As shown in FIG. 3, the bidirectional shift register 2015 controls the transmission direction of the data driving chip 20. The display panel could be scanned from its left to its right or from its right to its left. The signal CKN/P is a differential input signal carrying the display data information. The converting unit 2011 converts the differential input signal from a serial signal to a parallel signal and transfer the data of the (n+1)^{th} row to the first latch unit 2012. At this time, the second latch unit 2013 stores the data of the n^{th} row. This could ensure that the data of a previous row could be send at the same time when the data of the next row are received. Therefore, the data latch unit 2013 transfers the data of the n^{th} row to the level shifter unit 2014. The level shifter 2014 raises the data voltage transferred from the second latch unit 2013 from 3.3V to 16.8V (VA display screen) such that the DAC 2031 of the analog circuit is driven to convert the data voltage into an analog data voltage to drive the display panel to work.

Please refer to FIG. 4a and FIG. 4b. FIG. 4a shows information of a frame (from the first row to the last row) transferred from a timing controller to a data driving chip. The data structure (format) of each row is CT+CS+CMD+RGB data+CE. CT represents a specific code pattern for the communication between the timing controller and the data driving chip. For example, it could predefine that “011111000” is the CT code pattern. CS is also a predefined fixed code pattern for the following command CMD, which could be used to assign different functions. RGB data represents RGB valid information for displaying images. CE represents that the data transmission is completed.

The data driving chip 20 according to an embodiment includes a signal identifying circuit 202 between the digital signal processing circuit 201 and the analog signal processing circuit 203. In this way, the signal in the display data signal could be identified. When the signal identifying circuit 202 identifies the invalid display command signal, the signal identifying circuit 202 controls the invalid display signal not to be outputted to the analog signal processing circuit 203 such that the power consumption could be reduced.

Please refer to FIG. 5. FIG. 5 is a diagram of a display device according to an embodiment of the present disclosure. The display device 1000 comprises a display panel 1001 and a data driving chip 1002. The data driving chip 1002 is electrically connected to the display panel 1001. The data driving chip 1002 could be any one of the above-mentioned data driving chips and thus further illustration is omitted for simplicity.

The display device according to an embodiment includes a signal identifying circuit between the digital signal processing circuit and the analog signal processing circuit. In this way, the signal in the display data signal could be identified. When the signal identifying circuit identifies the invalid display command signal, the signal identifying circuit controls the invalid display signal not to be outputted to the analog signal processing circuit such that the power consumption could be reduced.

Above are embodiments of the present disclosure, which does not limit the scope of the present disclosure. Any modifications, equivalent replacements or improvements within the spirit and principles of the embodiment described above should be covered by the protected scope of the disclosure.

What is claimed is:

1. A data driving chip, comprising:
a digital signal processing circuit, configured to process a display data information to output a display data signal, wherein the display data signal comprises an invalid display command signal and an invalid display signal and the invalid display command signal is corresponding to the invalid display signal;
an analog signal processing circuit, configured to receive the display data signal and convert the display data signal from a digital signal into an analog signal to output an actual data voltage; and
a signal identifying circuit, electrically connected to the digital signal processing circuit and the analog signal processing circuit, configured to control the invalid display signal not to be outputted to the analog signal processing circuit when the signal identifying circuit identifies the invalid display command signal.

2. The data driving chip of claim 1, wherein the display data signal further comprises a valid display signal; and signal identifying circuit is further configured to control the invalid signal to be outputted to the analog signal processing circuit when the signal identifying circuit does not identify the invalid display command signal.

3. The data driving chip of claim 2, wherein the signal identifying circuit comprises an identifying unit and a switch unit;
wherein an input end of the identifying unit receives the display data signal, an output end of the identifying unit is electrically connected to a control end of the switch unit, and the identifying unit is configured to identify the display data signal; and
wherein an input end of the switch unit receives the display data signal, an output end of the switch unit is electrically connected to the analog signal processing circuit; when the identifying unit identifies the invalid display command signal, the identifying unit turns off the switch unit such that the invalid display signal is not outputted to the analog signal processing circuit; and when the identifying unit does not identify the invalid display command signal, the identifying unit turns on the switch unit such that the invalid display signal is outputted to the analog signal processing circuit.

4. The data driving chip of claim 3, wherein the switch unit is a thin film transistor (TFT), the control end of the switch unit is a gate of the TFT, the input end of the switch unit is a source of the TFT and the output end of the switch unit is a drain of the TFT.

5. The data driving chip of claim 4, wherein the switch unit is an N-type TFT or a P-type TFT.

6. The data driving chip of claim 1, wherein the display data signal comprises a valid display command signal and a valid display signal and the valid display command signal is corresponding to the valid display signal;
wherein when the signal identifying circuit identifies the valid display command signal, the signal identifying circuit controls the valid display signal to be outputted to the analog signal processing circuit.

7. The data driving chip of claim 1, wherein the digital processing circuit comprises a converting unit, a first latch unit, a second latch unit and a level shifter unit, the converting unit is electrically connected to the first latch unit, the first latch unit is electrically connected to the second latch unit, and the second latch is electrically connected to the level shifter unit;
wherein the converting unit is configured to receive the display data information, convert the display data information from serial data into parallel data, and transfer a display data signal of a (n+1)^{th} row to the first latch unit, and n is an integer greater than 0;
wherein the first latch unit is configured to store the display data signal of the (n+1)^{th} row data and transfer a display data signal of an n^{th} row data to the second latch unit;
wherein the second latch unit is configured to store the display data signal of the n^{th} row data and transfer the display data signal of the n^{th} row data to the level shifter unit;
wherein the level shifter unit is configured to raise a voltage level of the display data signal of the n^{th} row data and output the display data signal of the n^{th} row data having a raised voltage level to the signal identifying circuit.

8. The data driving chip of claim 7, wherein the digital signal processing circuit further comprises:
a bidirectional shift register, electrically connected to the converting unit, configured to control a scan direction of the data driving chip.

9. The data driving chip of claim 1, wherein the analog signal processing unit comprises:
a digital-to-analog converter, configured to receive the display data signal and convert the display data signal from a digital signal to an analog signal; and
an output buffer, electrically connected to the DAC, configured to output a data voltage according to the analog signal.

10. A display device, comprising:
a display panel; and
a data driving chip, electrically connected to the display panel, comprising:
a digital signal processing circuit, configured to process a display data information to output a display data signal, wherein the display data signal comprises an invalid display command signal and an invalid display signal and the invalid display command signal is corresponding to the invalid display signal;
an analog signal processing circuit, configured to receive the display data signal and convert the display data signal from a digital signal into an analog signal to output an actual data voltage; and
a signal identifying circuit, electrically connected to the digital signal processing circuit and the analog signal processing circuit, configured to control the invalid display signal not to be outputted to the analog signal processing circuit when the signal identifying circuit identifies the invalid display command signal.

11. The display device of claim 10, wherein the display data signal further comprises a valid display signal; and signal identifying circuit is further configured to control the invalid signal to be outputted to the analog signal processing circuit when the signal identifying circuit does not identify the invalid display command signal.

12. The display device of claim 11, wherein the signal identifying circuit comprises an identifying unit and a switch unit;
wherein an input end of the identifying unit receives the display data signal, an output end of the identifying unit is electrically connected to a control end of the switch unit, and the identifying unit is configured to identify the display data signal; and
wherein an input end of the switch unit receives the display data signal, an output end of the switch unit is electrically connected to the analog signal processing circuit; when the identifying unit identifies the invalid display command signal, the identifying unit turns off the switch unit such that the invalid display signal is not outputted to the analog signal processing circuit; and when the identifying unit does not identify the invalid display command signal, the identifying unit turns on the switch unit such that the invalid display signal is outputted to the analog signal processing circuit.

13. The display device of claim 12, wherein the switch unit is a thin film transistor (TFT), the control end of the switch unit is a gate of the TFT, the input end of the switch unit is a source of the TFT and the output end of the switch unit is a drain of the TFT.

14. The display device of claim 13, wherein the switch unit is an N-type TFT or a P-type TFT.

15. The display device of claim 10, wherein the display data signal comprises a valid display command signal and a valid display signal and the valid display command signal is corresponding to the valid display signal;
wherein when the signal identifying circuit identifies the valid display command signal, the signal identifying circuit controls the valid display signal to be outputted to the analog signal processing circuit.

16. The display device of claim 10, wherein the digital processing circuit comprises a converting unit, a first latch unit, a second latch unit and a level shifter unit, the converting unit is electrically connected to the first latch unit, the first latch unit is electrically connected to the second latch unit, and the second latch is electrically connected to the level shifter unit;
wherein the converting unit is configured to receive the display data information, convert the display data information from serial data into parallel data, and transfer a display data signal of a (n+1)^{th} row to the first latch unit, and n is an integer greater than 0;
wherein the first latch unit is configured to store the display data signal of the (n+1)^{th} row data and transfer a display data signal of an n^{th} row data to the second latch unit;
wherein the second latch unit is configured to store the display data signal of the n^{th} row data and transfer the display data signal of the n^{th} row data to the level shifter unit;
wherein the level shifter unit is configured to raise a voltage level of the display data signal of the n^{th} row data and output the display data signal of the n^{th} row data having a raised voltage level to the signal identifying circuit.

17. The display device of claim 16, wherein the digital signal processing circuit further comprises:
a bidirectional shift register, electrically connected to the converting unit, configured to control a scan direction of the data driving chip.

18. The display device of claim 10, wherein the analog signal processing unit comprises:
a digital-to-analog converter, configured to receive the display data signal and convert the display data signal from a digital signal to an analog signal; and
an output buffer, electrically connected to the DAC, configured to output a data voltage according to the analog signal.
